(19) United States
(12) Patent Application Publication
(10) Pub. No.: US 2003/0027351 A1
(43) Pub. Date: Feb. 6, 2003

(54) Monitoring of chemical reactions using interdigital cantilevers

(76) Inventors: Scott Manalis, California, CA (US); Juergen Fritz, Cambridge, MA (US); Emily Cooper, Cambridge, MA (US)

Correspondence Address: TESTA, HURWITZ & THIBEAULT, LLP, HIGH STREET TOWER, 125 HIGH STREET, BOSTON, MA, 02110, US

(21) Appl. No.: 09/921,395

(22) Filed: Aug. 2, 2001

(51) Int. Cl. G01N 21/41

(52) U.S. Cl. 436/165; 436/34; 436/164; 422/50; 422/55; 422/57; 422/61; 422/69; 422/82.05; 422/82.09; 422/83; 422/88; 422/91

(57) ABSTRACT

Chemical reactions are monitored by a cantilever sensing arrangement in which the reaction is transduced into mechanical responses that may be detected with a high degree of sensitivity. Projecting fingers interdigitate and, based on the extent of reaction, bend in a manner that may be detected optically.

### FIELD OF THE INVENTION

The present invention relates to measurement instruments, and in particular to instruments for measuring the progress of chemical reactions.

### BACKGROUND OF THE INVENTION

The progress and efficiency of chemical reactions are typically measured indirectly, e.g., through optical monitoring if the reaction produces an observable change in light-absorption characteristics, or by changes in mass or volume. These measurements typically operate on a gross scale and, as a result, require substantial amounts of reactants. For this same reason, measurement sensitivity is frequently limited.

More recently, small interdigital cantilevers have been proposed to facilitate monitoring of chemical reactions and interactions on a microscopic scale. The reaction is transduced into mechanical responses in the cantilever arrangement, which are detected optically with a high degree of sensitivity.

A typical interdigital cantilever arrangement includes a rigid substrate, a cantilever arm, and sets of opposed, flexible fingers projecting from the substrate and the arm. The sets of fingers interdigitate in an alternating fashion. The material of the fingers is chosen to reflect the light emitted by a monochromatic light source (e.g., a laser) so as to form a phase-sensitive diffraction grating (i.e., a reflection grating). See, e.g., Manalis et al., Appl. Phys. Lett. 69:3944-3946 (1996). As a result, the degree of displacement between sets of fingers is revealed by diffraction modes; it is unnecessary to measure the deflection directly.

To serve as a chemical sensor, the cantilever arm is typically much thinner than the substrate, and can bend. If a chemical reaction occurs on the surface of the cantilever arm, it will tend to deflect. This results not primarily from changes in mass on the cantilever arm, but instead from surface stress induced by intermolecular forces (arising from, for example, adsorption of small molecules). Bending of the cantilever arm causes the sets of fingers to separate, and the degree of separation—and hence the progress of the reaction—may be detected optically.

Thundat et al., 77 Appl. Phys. Lett. 77:4061-4063 (2000), describe such an arrangement using cantilever arms with fingers projecting from each side in opposite directions. These interdigitate with complementary fingers projecting from two opposed sides of a rigid frame that surrounds the cantilever arm and its fingers, and to which the cantilever arm is attached. The entire structure is functionalized with a chemically selective coating (such as gold) and then exposed to analytes reactive with the coating, causing the cantilever arm (and its fingers) to bend relative to the frame (and its immobile fingers). One problem with the approach described by Thundat et al. is the fact that the entire cantilever structure is functionalized with the same coating. While this approach can usefully provide an absolute indication of reaction and reactivity, it cannot be used to directly compare the reactivities of, for example, two different coatings. Indeed, the frame structure would also make it difficult, if not impossible, to apply different types of reactants to different portions of the device. The small size of the structure and the practical inaccessibility of its individual components render coating and exposure to reactants on a device-wide basis the only realistic approach.

Berger et al., Science 276:2021-2024 (1997), describe V-shaped micromechanical cantilevers that are individually accessible to, for example, a micropipette that may be used to place reactants thereon. This device utilizes a laser beam reflected off the cantilever's apex onto a photodiode to measure the degree of cantilever deflection. Thus, while this device is chemically programmable, it does not offer the benefits of an interdigital arrangement and the mode-based measurements these facilitate, nor, because each cantilever is self-contained and structurally distinct from the others, does the device permit differential measurements.

Finally, Fritz et al., Science 288:316-318 (Apr. 14, 2000) (hereafter “Fritz et al.”), describe the use of bendable cantilevers to facilitate optical monitoring of chemical reactions. Each cantilever is individually accessible to a different reactant, so that differential measurement is possible. For example, different receptor molecules may be immobilized on adjacent cantilevers, so that exposure of the overall device to a ligand will induce different degrees of binding and, hence, cantilever bending that may be detected optically. Once again, however, the detection mode is not interdigital; instead, the degree of bending of each cantilever is measured directly.

### DESCRIPTION OF THE INVENTION

Brief Summary of the Invention

The present invention overcomes the disadvantages of the prior art by providing, in one aspect, an interdigital chemical measurement arrangement that is spatially accessible, i.e., can be received, at least in part, within a pipette or contacted by another source of reactants or reagents without obstruction. This is preferably accomplished by having at least one set of fingers project from a flexible platform or base that is, at least in part, spatially unhindered. The finger-bearing platform may have a free end configured to receive reactants or reagents, e.g., from a pipette.

In another aspect, the invention provides an interdigital chemical measurement arrangement that facilitates differential rather than (or in addition to) absolute measurements; that is, the relative degree of bending (and, hence, reaction) caused by different reactants can be measured directly. This is preferably accomplished by providing two or more sets of interdigitating fingers, each set projecting from adjacent flexible platforms or bases. The bases may, for example, project in parallel opposition from a common substrate. In this way, different reactants can be applied to the different platforms and the relative degrees of bending detected. If desired, each base may also include an additional set of fingers interdigitating with fingers projecting from the substrate, thereby facilitating absolute measurements.

A preferred embodiment comprises a rigid substrate and, projecting therefrom, at least one cantilever base. The cantilever base has a surface and/or a free end for receiving one or more reactants. Projecting from the cantilever base is a set of spaced-apart elongated fingers. A second set of fingers projects from, for example, another portion of the substrate (e.g., the substrate may have a U-shaped configuration whereby the cantilever base projects from one leg and the substrate-bound fingers project oppositely, from the other leg). The first and second sets of fingers are spaced apart so that the fingers of one set interdigitate with the fingers of the other set. A sensor detects reaction of species associated with one set of fingers based on its displacement with respect to the other set. For example, a reactant may be deposited on a cantilever base and then treated (e.g., through exposure to actinic radiation or chemicals) so as to bind to the base. Once again, the device may comprise two flexible cantilever bases projecting from the substrate in parallel opposition. Interdigitating sets of fingers project from each of the bases, thereby facilitating differential measurements.

The invention also comprises a method of monitoring a chemical reaction. A representative method begins with a cantilever arrangement comprising a rigid substrate. A flexible cantilever base projects from the substrate, and a set of spaced-apart, elongated fingers projects from the base. These interdigitate with another set of fingers (located, for example, on the substrate or on another cantilever base). The cantilever base has a surface and a free, accessible end for receiving a reactant, and one or more reactants are applied thereto. A chemical reaction is detected based on displacement between the sets of fingers.

### BRIEF DESCRIPTION OF THE DRAWINGS

The foregoing discussion will be understood more readily from the following detailed description of the invention, when taken in conjunction with the accompanying drawings, in which:

FIG. 1 is a plan view of a first embodiment of a measurement device in accordance with the invention;

FIG. 2 is a plan view of a second embodiment of a measurement device in accordance with the invention; and

FIG. 3 schematically illustrates operation of the invention.

The various elements may not be drawn to scale.

### DETAILED DESCRIPTION OF THE PREFERRED EMBODIMENTS

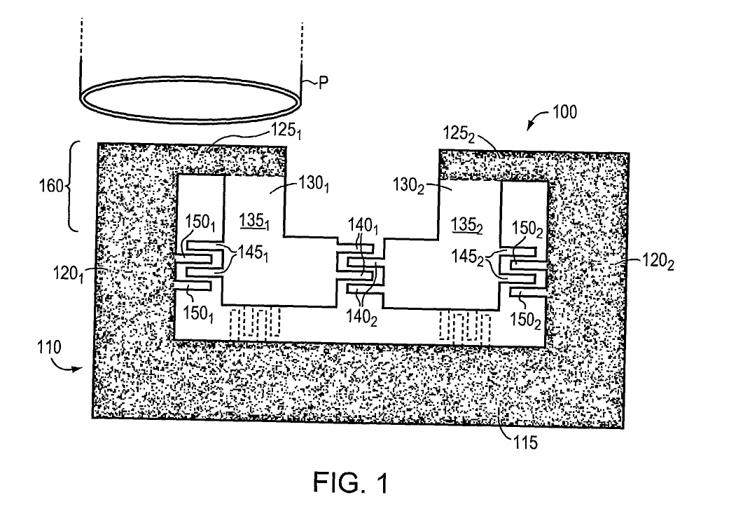

With reference to FIG. 1, a representative embodiment 100 of the invention facilitating has a rigid substrate 110 organized into a transverse section 115 and a pair of legs 120₁, 120₂ extending in parallel from the transverse section 115. Each leg 120₁, 120₂ terminates in a foot 125₁, 125₂, each foot extending transversely with respect to the associated leg and toward the opposite foot. The body, legs and feet of substrate 110 are preferably all contiguous and of similar thicknesses, but in any case are all sufficiently thick (as indicated by shading) to remain rigid during use of the device 100.

Projecting from feet 125₁, 1252 back toward transverse section 115 are a pair of cantilever bases 130₁, 130₂. The cantliever bases are in parallel opposition, and each has a surface 135₁, 135₂ for receiving a reactant. Bases 130₁, 130₂ are substantially thinner than substrate 110, and bend in response to chemical reactions occurring thereon.

Each cantilever base 130₁, 130₂ has an associated set of fingers representatively indicated at 140₁, 140₂, which are complementary and interdigitate with each other. This arrangement allows the different chemical responses of surfaces 135₁, 135₂ to different reactants to be measured differentially. For example, the same receptor molecule may be immobilized on surfaces 135₁, 135₂. By exposing each surface to a different ligand, the relative affinities of the ligands for the receptor molecule may be measured directly from the different degrees of surface bending they induce. (Alternatively, different receptor molecules may be immobilized on the surfaces, which receive the same ligand.)

Each foot segment 125, along with a portion 160 of leg 120 and base 135, may be received within the mouth of a pipette P, which facilitates deposition of reactants on the surface 135. Initially, fingers 140₁, 140₂ interdigitate in a coplanar fashion. Application of a reactant (in liquid form, or dispersed in a liquid carrier) to a surface 135 does not, in general, cause substantial bending of the associated base 130—although if it does, the observed bending amount can be used as a baseline. The reactant may be treated (e.g., by exposure to actinic radiation, heating, chemical immersion, etc.; for example, oligonucleotides can be covalently bound to gold-surfaced cantilevers as described in Fritz et al.) so as to bind tightly to surfaces 135. A reactant may then be introduced onto surfaces 135 by pipettes. Although the pipette does not receive the entirety of a surface 135, the regions where the surfaces 135 join feet 125 represent the most critical areas for measurement purposes, since deflection is effectively amplified along the lengths of the surfaces (that is, the angle of deflection remains constant but the degree of linear displacement increases along the length of the surface).

When the reactant undergoes reaction, surface effects cause flexible cantilever bases 130₁, 130₂ to bend; and if bases 130₁, 130₂ undergo different degrees of bending, the fingers 140₁, 140₂ will be displaced from coplanarity. The degree of displacement is determined by means of a monochromatic light source and a photodetector, as discussed in greater detail below. The material of fingers 140 is chosen to reflect the light emitted by the source so as to form a phase-sensitive diffraction grating (i.e., a reflection grating), and the displacement between fingers 140₁, 140₂ may be determined by measuring the intensity of the diffracted modes.

Moreover, if desired, each cantilever base 130₁, 130₂ may have an additional set of fingers 145₁, 145₂, respectively, interdigitating with a complementary set of fingers projecting 150₁, 150₂ projecting from substrate 110. (Fingers 145₁, 145₂ may project from the sides of bases 130₁, 130₂ as shown, or from the bottom segments as indicated by dashed lines.) This facilitates simultaneous, side-by-side measurement of the absolute degrees of bending of each surface 135₁, 135₂ relative to substrate 110 (e.g., using separate light sources and photodetectors).

When the interdigitated fingers are illuminated, the light is diffracted into a series of optical beams that correspond to different reflection modes. In the far field, the lateral spacing between the beams is approximately 2hλ/d, where h is the distance between the fingers and a photodetector, d is the spacing between the fingers themselves, and λ is the illumination wavelength. In other words, if h is assumed to lie along the z axis, the lateral spacing among beams occurs on the x,y plane.

In a typical implementation, d=6 μm, h is a few centimeters, and λ may be 635 nm. This provides a lateral spacing of a few millimeters between the diffraction-mode spots. The fingers 140, 150 may be on the order of 3 μm in width and spaced apart by a pitch of 6 μm. With reference to fingers 145₁, 150₁ for illustrative purposes, when the reflective grating formed by fully interdigitated fingers is illuminated with monochromatic light, the majority of the light will be reflected back toward the source; this is the “zeroth” mode of reflection. The intensity of the 0^{th}-order beam varies as cos²(2πs/λ), where s is the displacement between the bent and straight fingers 145₁, 150₁, respectively. If fingers 145₁, 150₁ are displaced from each other by a distance equal to one-fourth of the illumination wavelength, λ, the 0^{th}-order mode is cancelled and most of the light is diffracted into two first-order modes of reflection (i.e., the −1^{st}-order mode and the +1^{st}-order mode, depending on the direction of bending); this occurs because the light reflected by one set of fingers partially interferes with the light reflected by the other set of fingers. If the alternating fingers are separated by λ/4, light from the displaced fingers 145₁ is delayed by half a wavelength relative to light reflected by fingers 150₁, and destructively interferes with that light. Accordingly, the intensity of the 0^{th}-order mode is minimal at a spacing of λ/4, where the 1^{st}-order modes are maximal; the intensity variations vary sinusoidally with a period of λ/2. The best performance therefore occurs with displacements around λ/8, since at this point in the curve the slope variation is maximal (so that a given displacement produces the greatest measurable effect on intensity).

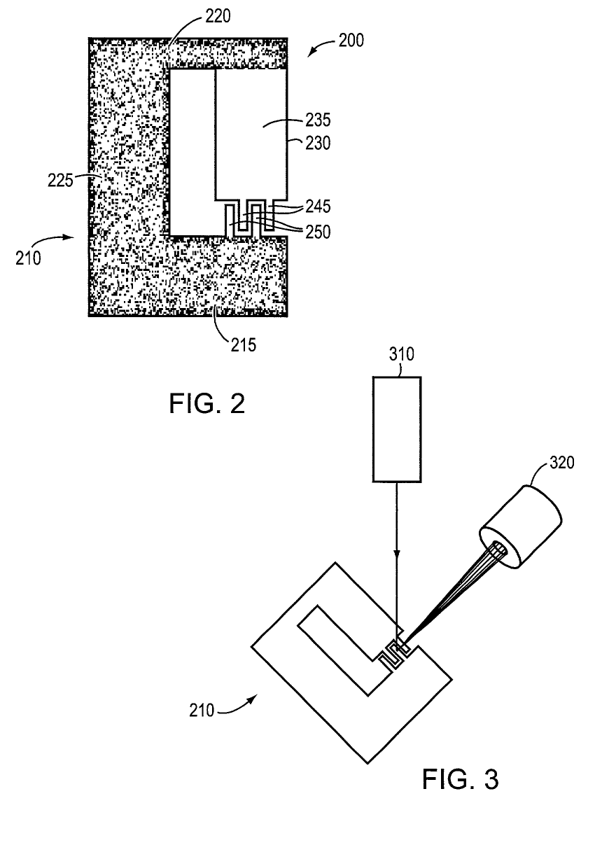

FIG. 2 illustrates a simpler measurement device 200, which is useful when only absolute (and not differential) measurements are required. The device 200 includes a generally U-shaped fixture or substrate 210 having a pair of opposed legs 215, 220 and a transverse section 225. Projecting from leg 220 is a flexible cantilever base 230. Base 230 is substantially thinner than substrate 210, which allows the base to bend relative to the rigid substrate. Cantilever base 230 has a surface 235 for receiving a reactant, typically in liquid form. Projecting from cantilever base 230 is a first set of fingers 245. A second, complementary set of fingers 250, interdigitating alternately with fingers 245, projects from leg 215 of substrate 210. The device 200 can operate with as few as two fingers 240, 245, although the optimal number of fingers is ten. (This range also applies to the embodiments described above.) A multisensor device can be manufactured using a common leg 215 from which multiple transverse sections, opposed legs and bases project.

With reference to FIG. 3, the interdigitating fingers of either of the devices described herein may be illuminated by a laser 310, and reflected light is sensed by a photodetector 320. For example, photodetector 320 may be a solid-state device utilizing one or more semiconductor photodiodes, which detect light when photons excite electrons from immobile, bound states of the semiconductor (the valence band) to mobile states (the conduction band) where they may be sensed as a photoinduced current. Even a single photodiode may be used to record the intensity of a given diffracted mode.

Although the present invention has been described with reference to specific details, it is not intended that such details should be regarded as limitations upon the scope of the invention, except as and to the extent that they are included in the accompanying claims.

What is claimed is:

1. A device for facilitating monitoring of a chemical reaction, the device comprising:
a. a rigid substrate and, projecting from the substrate, a first set of spaced-apart, elongated fingers;
b. a flexible cantilever base comprising a surface at least a portion of which is spatially unhindered to facilitate deposition thereon of chemical species and, projecting from the base, a second set of spaced-apart, elongated fingers interdigitating with the first set of fingers; and
c. a sensor for detecting reaction occurring on the surface based on displacement between the sets of fingers.

2. The device of claim 1 wherein the substrate comprises a third set of fingers projecting therefrom, the device further comprising another flexible cantilever base comprising a surface at least a portion of which is spatially unhindered to facilitate deposition thereon of chemical species and, projecting from the base, a fourth set of spaced-apart, elongated fingers interdigitating with the third set of fingers.

3. The device of claim 2 wherein the cantilever bases are in parallel opposition and further comprise fifth and sixth sets of interdigitating fingers facilitating differential detection of reactions on the bases.

4. The device of claim 1 wherein the sensor comprises:
a. a source of monochromatic light directed at the sets of fingers, the fingers causing diffraction of the light; and
b. an optical detector for measuring the diffracted light to determine the displacement between the first and second sets of fingers.

5. The device of claim 1 wherein the cantilever base has a spatially unhindered end including at least a portion of the surface and extending beyond the fingers.

6. A device for facilitating differential monitoring of chemical reactions, the device comprising:
a. first and second flexible cantilever bases in parallel opposition, each base comprising a surface for receiving a chemical species and, projecting from the base, a set of spaced-apart, elongated fingers, the sets of fingers interdigitating with each other; and
b. a sensor for detecting relative degrees of reaction occurring on the surfaces based on relative displacement between the sets of fingers.

7. The device of claim 6 wherein at least a portion of the surfaces of the cantilever bases are spatially unhindered to facilitate deposition thereon of different chemical species.

8. The device of claim 6 further comprising a substrate from which both cantilever bases project.

9. A method of monitoring a chemical reaction, the method comprising the steps of:
a. providing a cantilever arrangement comprising (i) a rigid substrate, (ii) projecting from the substrate, a first set of spaced-apart, elongated fingers, (iii) a flexible cantilever base comprising a surface at least a portion of which is spatially unhindered to facilitate deposition thereon of chemical species, and (iv) projecting from the base, a second set of spaced-apart, elongated fingers interdigitating with the first set of fingers;
b. applying at least one reactant to the surface of the base; and
c. detecting reaction of the at least reactant based on displacement between the sets of fingers.

10. The method of claim 9 wherein the measurement step comprises:
a. directing a source of monochromatic light at the sets of fingers, the fingers causing diffraction of the light; and
b. detecting the diffracted light and, based thereon, determining the displacement between the first and second sets of fingers.

11. The method of claim 9 wherein the applying step comprises receiving at least a portion of the base in a pipette carrying the reactant.

12. A method of monitoring a chemical reaction, the method comprising the steps of:
a. providing a cantilever arrangement comprising first and second flexible cantilever bases in parallel opposition, each base comprising (i) a surface for receiving a chemical species, and (ii) projecting from the base, a set of spaced-apart, elongated fingers, the sets of fingers interdigitating with each other;
b. applying at least one reactant to the surface of each base; and
c. detecting relative degrees of reaction on the bases based on displacement between the sets of fingers.

13. The method of claim 12 wherein the measurement step comprises:
a. directing a source of monochromatic light at the sets of fingers, the fingers causing diffraction of the light; and
b. detecting the diffracted light and, based thereon, determining the displacement between the first and second sets of fingers.

14. The method of claim 12 wherein the applying step comprises receiving at least a portion of the base in a pipette carrying the reactant.
